(19) United States
(12) Patent Application Publication
(10) Pub. No.: US 2005/0097120 A1
(43) Pub. Date: May 5, 2005

(54) Systems and methods for organizing data

(75) Inventors: Matthew L. Cooper, San Francisco, CA (US); Jonathan T. Foote, Menlo Park, CA (US); Andreas Girgensohn, Menlo Park, CA (US)

Correspondence Address: OLIFF & BERRIDGE, PLC, P.O. BOX 19928, ALEXANDRIA, VA, 22320, US

(73) Assignee: FUJI XEROX CO., LTD., Minato-ku (JP)

(21) Appl. No.: 10/729,915

(22) Filed: Dec. 9, 2003

Related U.S. Application Data
(60) Provisional application No. 60/515,713, filed on Oct. 31, 2003.

(51) Int. Cl. G06F 17/00

(52) U.S. Cl. 707/102

(57) ABSTRACT

Data organizing systems and methods organize a plurality of data files using meta data or other data relating to a plurality of data files by extracting the related data for at least some of the data files, organizing the extracted related data and dividing at least some of the data files into groups based on the extracted related data and an input parameter value.

This non-provisional application claims the benefit of U.S. Provisional Application No. 60/515,713, filed on Oct. 31, 2003. The disclosure of the prior application is incorporated herein by reference in its entirety.

### BACKGROUND OF THE INVENTION

1. Field of Invention

This invention is directed to systems and methods for organizing data by hierarchical clustering of the data.

2. Description of Related Art

Data is stored in various ways, such as, for example, in media files as media data. Media data maybe media streams or files, such as, for example, audio, video, graphic and/or text streams or files. One exemplary form of media data is digital photographs. The affordability of high quality digital cameras has enabled digital photography to proliferate, allowing millions to easily take and store digital photographs. These digital photographs are often stored as digital photograph data files.

Media data files usually include several different parts. For example, a digital photograph data file may include image data recorded in a particular file format, such as, for example, the JPEG format. Along with the image data, certain information about the image data may be typically stored as meta-data in the resulting digital photograph data file and that is associated with the image data. The associated meta-data is a separate and distinct data from the underlying image data. One exemplary format is the exchangeable image file format (Exif), which is often used as the format for the header information that is stored as part of the JPEG image data file. Examples of stored meta-data in the Exif format include the file name, one or more timestamps, such as the time the data was created, the time when last change to the image file occurred, short descriptions of the image data, or the GPS location for the place the image data was obtained.

Many techniques have been created for managing digital photograph data files and other such rapidly accumulating data files. For simple data files, one such technique involves placing such data files into specific folders depending on a topic that each such data file is associated with. Another technique involves manually organizing one's contact information into a given file directory within a personal computer database. The user reviews the content and determines the placement of the specific contact information in a file directory, and any sub-categories, such as friends, business contact, school contact, and the like.

Even such simple data as contact information written in a particular format, such as the format used in Microsoft Word®, contains two features. The name of the data record that identifies the data can be called a scalar feature that condenses the information that is contained within the record. The actual contents of the record, such as the name of the contact, the contact's address, or other data pertaining to that specific contact, are more detailed and can be called vector features.

One way to organize data files is for a user to actually examine the content of each data file and/or the name of that data file, and subsequently manually determine an appropriate location of that data file within a specific file directory structure, such as a folder labeled with an appropriate topic descriptor. Placing and gathering data files into specific locations organizes the data files into specific relationships. However, when, for example, tens of thousands of photographs have to be organized, manually organizing each data file becomes nearly impossible. The difficulty is amplified when the content of each data file is complicated, such as, for example, when the content is image data.

### SUMMARY OF THE INVENTION

This invention provides systems and method for efficiently organizing data based on meta-data or other ordered information within data files.

This invention separately provides systems and methods for organizing data files by clustering related data files based on organizing meta-data of a data file.

This invention separately provides systems and methods for extracting the meta-data of a data file.

This invention separately provides systems and methods for organizing the data files based on the meta-data of the data files.

This invention separately provides systems and methods for organizing desired data files for browsing and/or retrieval.

In various exemplary embodiments of the systems and methods according to this invention, a desired set of data files is organized by examining a set of meta-data, where each meta-data element of the meta-data is extracted from, or at least has been associated with, a particular data file. In various exemplary embodiments, a structure within the set of meta-data is assessed by obtaining a desired range of values of an element of the meta-data for analyzing the meta-data elements, then comparing the values for that element of the meta-data for all or a subset of the data files.

In various exemplary embodiments, the meta-data elements of the set of meta-data are clustered using the assessed structure of the set of meta-data. The structure of the set of meta-data includes boundaries that delineate each cluster of meta-data element values from other clusters. In various exemplary embodiments, the value of one meta-data element of one data file is compared to the value of that meta-data element of another data file in the clusters based on the range value to determine the similarity or dissimilarity between the compared data files.

In various exemplary embodiments, the data is organized using a comparison between all possible pairs of data or a subset of all possible pairs of data. In various exemplary embodiments, the compared similarity or dissimilarity is given a numerical value corresponding to a placement of the clusters of the meta-data elements and their corresponding data files. In various exemplary embodiments, the placement of the clusters is checked for greater accuracy. In various exemplary embodiments, the data files are organized more efficiently and computationally less expensively than when generating low level features by constructing content-base similarity measures.

These and other features and advantages of this invention are described in, or apparent from, the following detailed description of various exemplary embodiments of the method and apparatus according to this invention.

### BRIEF DESCRIPTION OF THE DRAWINGS

Various exemplary embodiments of this invention will be described in detailed, with reference to the following figures, wherein:

FIG. 1 is a flowchart outlining one exemplary embodiment of a method for organizing data according to this invention;

FIG. 2 is a flowchart outlining in greater detail one exemplary embodiment of the method for organizing the desired data according to this invention;

FIGS. 3 and 4 graphically illustrates one exemplary embodiment of results obtained for a similarity matrix and a novelty score;

FIGS. 5-10 graphically illustrates exemplary embodiments of results obtained for a plurality of similarity matrixes and their corresponding novelty scores.

FIG. 11 graphically illustrates one exemplary embodiment of a novelty score determined for boundaries varying with parameter K values;

FIGS. 12 and 13 graphically illustrates exemplary embodiments of similarity matrixes determined for two distinct parameter K values;

FIG. 14 graphically illustrates one exemplary embodiment of a confidence score;

FIGS. 15-17 graphically illustrates exemplary embodiments of similarity matrix for three different parameter K values; and

FIG. 18 is a block diagram of one exemplary embodiment of data organizing system according to this invention.

### DETAILED DESCRIPTION OF EXEMPLARY EMBODIMENTS

The following detailed description of various exemplary embodiments of systems and methods according to this invention is focused on organizing desired data based on processing of meta-data corresponding to a data file. However, it should be appreciated that this invention is not limited to only the disclosed exemplary embodiments. In general, this invention can be used with any method or apparatus that organizes multitudes of data using corresponding meta-data.

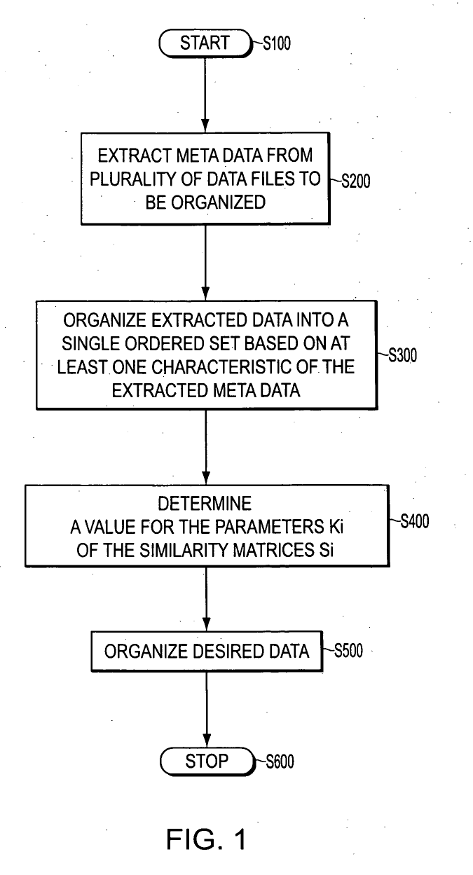

FIG. 1 is a flowchart outlining one exemplary embodiment of a method for organizing data according to this invention. In various exemplary embodiments, the method outlined in FIG. 1 can be used to organize a plurality of data files of any desired type of data based on meta-data within and/or associated with that plurality of data files.

As shown in FIG. 1, operation of the method begins in step S100, and continues to S200, where at least one element of the meta-data of each data file is extracted from the plurality of data files to be organized. Next, in step S300, the extracted meta-data elements are organized into a set based on values for one or more of the extracted meta-data elements and given a designation, for example, a desired order and identification within the set. Operation then continues to step S400.

In step S400, a value for a parameter K is selected. Next, in step S500, the meta-data is organized hierarchically as desired. Operation then continues to step S600, where operation of the method ends.

It should be appreciated that, in various exemplary embodiments, the extracted meta-data element may be organized chronologically, if, for example, the at least one extracted element of the meta-data includes a timestamp element. Alternatively, the meta-data element may be organized alphabetically if the at least one extracted element of the meta-data includes a file name or some other text string. In still other various exemplary embodiments, the meta-data element may be organized numerically if the at least one extracted meta-data element of the meta-data includes numerical data. In yet other various exemplary embodiments, the at least one extracted meta-data element of the meta-data may define a location, such as, for example, GPS data. It should be appreciated that any other appropriate meta-data element, in addition to or in place of the time, alphabetical, numerical and/or positional meta-data elements described above, can be used as an organizing characteristic. It should also be appreciated that any known or later-developed way of ordering or organizing the values of the selected meta-data element(s) may be used to organize the data files into a desired order.

In various exemplary embodiments, each extracted meta-data element is given a desired identification, or indexed. As a result, in such exemplary embodiments, each data file is thus identified based not on the actual value of the organizing meta-data element in terms of the time, name, or location, but by the location of the value of that meta-data element, within the set of data files. In other words, as an example, a set of data files are organized chronologically based on the values of a timestamp meta-data element. However, the data files are then identified, or indexed, by the order they are located in the set of data files in view of the time values of the timestamp meta-data elements, not by the absolute time values of the timestamp meta-data elements. Nevertheless, the meta-data element for each data file continues to retain its absolute value, which can be compared later.

In various exemplary embodiments, the parameter K has a numerical value. The input value for the parameter K may be a default value or a desired value. In various exemplary embodiments, the parameter K is a value that determines the clustering sensitivity to pair-wise comparisons between the selected meta-data elements of each pair of data files in the set or a subset of pairs of data files in the set. Therefore, larger values of parameter K represent comparisons that result in coarser clustering of the data files. In other words, larger values of the parameter K require values for the meta-data that are further apart from each other to fall into separate clusters. On the other hand, smaller values for the parameter K can be tailored to integrate or emphasize specific features of the meta-data that become more or less apparent at either greater or lower values for the parameter K.

For example, a smaller value for the parameter K is typically more appropriate for a meta-data element having values that are very finely spaced, or features of meta-data that become more apparent at smaller differences. In contrast, a larger value for the parameter K is typically more appropriate for a meta-data element having values that are very coarsely spaced, or features of meta-data that become more apparent at greater differences. Consequently, the desired value for the parameter K will differ depending on the type of meta-data, the spacing of the meta-data, and the number of meta-data elements in the set. Therefore, in various exemplary embodiments, a plurality of values for the parameter K are used to fully analyze and compare the meta-data. Thus, in various exemplary embodiments according to this invention, no assumptions are made regarding an a priori distribution of the input set of meta-data elements. Various exemplary types of meta-data that can be analyzed and/or compared using such values for the parameter K include, for example, low level image features, GPS data, timestamps in hours, months, and/or years.

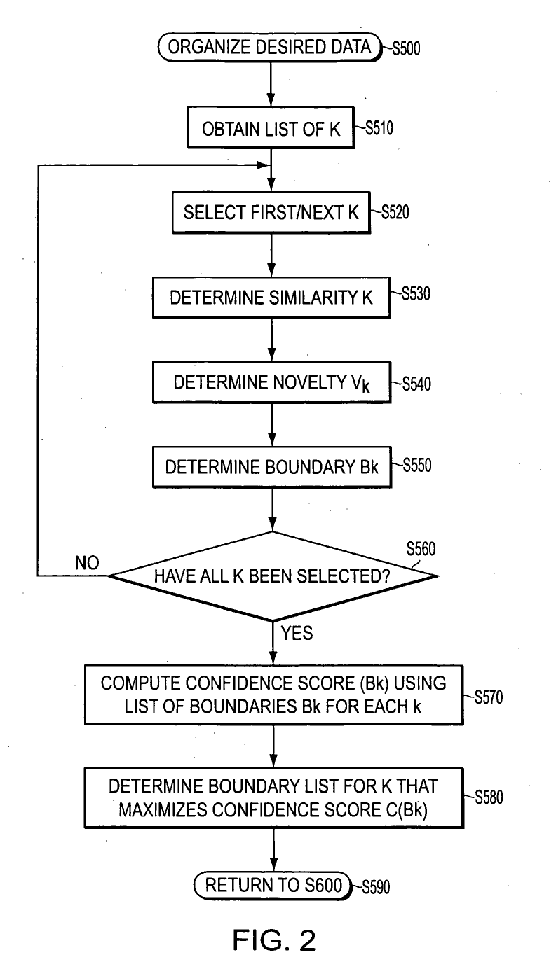

FIG. 2 is a flowchart outlining in greater detail one exemplary embodiment of the method for hierarchically organizing the desired meta-data of step S500. In various exemplary embodiments, the method outlined in FIG. 2 can be used to organize any desired set of data files by using its meta-data.

As shown in FIG. 2, operation of the method begins in step S500 and continues to step S510, where a list of values for the parameter K is obtained. Next, in step S520, the first or next value is selected from the list of values for the parameter K. Operation then continues to step S530.

The list of values for the parameter K corresponds to the values for the parameter K selected in step S400. In various exemplary embodiment, a list of values for the parameter K containing a plurality of different values for the parameter K can be either automatically generated, for example, randomly, can be based on a quick scan of the meta-data values, or can be manually input. In various exemplary embodiments, the values for the parameter K within the list contains a plurality of values for the parameter K.

In step S530, each of the values for the parameter K in the list is used to obtain a similarity value S_{K} for each pair of indexed meta-data elements in the list:

$${S}_{K} ( i , j ) = exp ( - \frac{\vert {t}_{i} - {t}_{j} \vert}{K} ) , \qquad ( 1 )$$

where:
S_{K} (i,j) is the similarity value for the i^{th} and j^{th} data files;
K is the value of the parameter K; and
tᵢ and tⱼ are actual values of the selected meta-data elements of the i^{th} and the j^{th} data files.

The collection of the similarity value SK for each compared pair of meta-data elements using a particular value for the parameter K can be expressed as a similarity matrix.

In other words, the meta-data for the i^{th} and j^{th} data files can be compared based on the parameter K to obtain the similarity value S_{K} for the values tᵢ and tⱼ of the meta-data elements of the i^{th} and j^{th} data files. As the t value is the actual value of the meta-data, in one exemplary embodiment, t can be a time in minutes if the meta-data is a timestamp.

The type of actual value of the meta-data elements that can be used to obtain a similarity value S_{K} need not be a scalar value such as time. Other types of meta-data elements can be used to obtain the similarity value S_{K}. In various exemplary embodiments, content-based feature vectors may also be used together with or in place of the meta-data. In this case, the similarity value is:

$${S}_{K} ( i , j ) = exp ( \frac{1}{K} ( \frac{\text{<} {v}_{i} , {v}_{j} \text{>}}{\vert {v}_{i} \vert \vert {v}_{j} \vert} - 1 ) ) . \qquad ( 2 )$$

where vᵢ and vⱼ are actual vectors for the selected meta-data element of the th and j data files. Other suitable types of values and equations may be used in various other exemplary embodiments. Operation then continues to step S540.

In step S540, a novelty score v_{K} is obtained for each elements of the similarity matrix S_{K} that has been generated for a particular value for the parameter K. One way to obtain the novelty share v_{K} is to use a matched filter technique to correlate a kernel along a main diagonal S(i,i) of the similarity matrix SK (i,j) That is, in various exemplary embodiments, the novelty score v_{K} is determined only along the diagonal of the similarity matrix S_{K}. To find the actual boundaries between the groups of meta-data, in various exemplary embodiments, a Gaussian tapered 11×11 checkerboard kernel, g is used to calculate the novelty score v_{K}(s) as:

$${v}_{K} ( s ) = {\sum }_{l , n = - 5}^{5} {S}_{K} ( s + 1 , s + n ) g ( 1 , n ) . \qquad ( 3 )$$

where v_{K}(s) is the novelty score for the i^{th} element of the similarity matrix S_{K} for a particular value for the parameter K and the Gaussian tapered 11×11 checkerboard kernel g.

In Eq. (3), the value for 1 and n range between −5 and +5 because an 11×11 matrix is used. In various exemplary embodiments, other sized matrices may be used, such as, for example, a 9×9 matrix, where the value for j and k range between −4 and 4. To obtain the novelty score v_{K}, any desired sized checkerboard kernel may be used.

By using a checkerboard kernel, a full analysis need not be performed. Rather, only the strip around the main diagonal with the same width as the kernel need be obtained, reducing the computational complexity, which linearly corresponds to the number of data files. It should be noted that comparisons of only subset of pairs of data, rather than all possible pairs of data, may be used in any pair-wise comparisons. In general, using only a subset of all possible pairs results in substantial computational savings with minimal performance degradation.

When the novelty scores v_{K} are determined for the various values of the parameter K, several peaks in the novelty score appear. It should be noted that different peaks appear for different values of the parameter K. Because the values for the parameter K represent a range of structure, the different values for the parameter K allow the similarity matrices S_{K} to reveal structures at different resolutions. The peaks in the novelty scores v_{K}, in turn, indicate a hierarchical set of boundaries between contiguous groups of data having similar or closer meta-data element values than other groups, i.e., clusters. Therefore, the peaks in the novelty scores v_{K} are boundaries between groups with similar meta-data values and indicate a cluster of meta-data values that are separable from other clusters. Therefore, the peaks in novelty scores v_{K}, which are boundaries between groups of meta-data, are obtained. Operation then continues to step S550.

In step S550, a boundary list for each different value of the parameter K is obtained, first by locating all the peaks in the novelty score v_{K} for each value of the parameter K, and enforcing a hierarchical structure on the detected boundaries. In various exemplary embodiments, the analysis to obtain a boundary list is done from a courser scale to a finer scale, or decreasing values for the parameter K, using each value in the list of values of the parameter K. All the peaks in the novelty scores v_{K} for each value of the parameter K is then collected to build a hierarchical set of peak values or boundaries using a boundary list B_{K}={b₁, . . . bₙₖ} that will include all boundaries detected. That is, all boundaries detected at course scales or greater values of the parameter K will be included in the boundary list for all finer scales or lesser values of the parameter K. It is assumed that boundaries between groups further apart obtained at courser scales still exits at finer scales.

The boundaries are located where the novelty score v_{K} is at a local maximum value, and is determined from the maximum of similarity measure and the kernel correlated along the main diagonal of the similarity matrix. Another way of obtaining the maxima or minima of the novelty score is to obtain a derivative of the Eq. (3) for example. The operation then continues to step S560.

In step S560, a determination is made whether all the values for the parameter K in the list have been used to determine the boundaries by obtaining the similarity value S_{K}, the novelty score V_{K}, and the boundary bₖ for each value of the parameter K. If not, the operation returns to step S520. Otherwise, operation continues to step S570.

In step S570, the detected boundaries represented by the list of boundaries B_{K} are used to obtain a confidence score C(B_{K}), which represent the results of the clustering that have been ranked for each level in the hierarchy of the detected boundaries. The confidence score C(B_{K}) is based on the average within-class similarity and the between class dissimilarity as represented by:

$$C ( {B}_{K} ) = {\sum }_{l = 1}^{\vert {B}_{K} \vert - 1} \frac{1}{{( {b}_{l + 1} - {b}_{1} )}^{2}} {\sum }_{i , j = {b}_{1}}^{{b}_{l + 1}} {S}_{K} ( i , j ) - {\sum }_{l = 1}^{\vert {B}_{K} \vert - 2} \frac{1}{( {b}_{l + 1} - {b}_{1} ) ( {b}_{l + 2} - {b}_{l + 1} )} {\sum }_{i = {b}_{1}}^{{b}_{l + 1}} {\sum }_{j = {b}_{l + 1}}^{{b}_{l + 2}} {S}_{K} ( i , j ) . \qquad ( 4 )$$

where:
C(B_{K}) is the confidence score; and
b is the detected boundary at each level.

As shown above, the first sum, which quantifies the average within-class similarity between the data files within each cluster, and the second sum, which quantifies the average between-class similarity between the data files in adjacent clusters, are negated to quantify the between-cluster dissimilarity. The rate of change for the first sum and the second sum vary depending on the value of the parameter K. Therefore, for a plurality of values for the parameter K, one value will allow the confidence score C(B_{K}) to be maximized. Consequently, operation continues to step S580, where the boundary list B_{K} for the value of the parameter K that maximizes the confidence score C(B_{K}) is obtained. Then, the operation proceeds to step S590, where the operation returns to step S600. Other types of statistical measures can be used to obtain the confidence score C(B_{K}), such as the Bayes information criterion (BIC). Some examples of the Bayes information criterion are set forth in “A tutorial on learning with Bayesian networks” by D. Heckermann, Technical Report MSR-TR-95-06, Microsoft Research, Redmond, Wash. (1995, Revised 1996); S. Chen et al., “Speaker, environment and channel change detection and clustering via the Bayesian information criterion”, DARPA Speech Recognition Workshop (1998); and by S. Renals et al., “Audio Information Access from Meeting Room” (April, 2003), each of which is incorporated herein by reference in its entirety.

One exemplary use of systems and methods according to this invention involves organizing digital photographs into time-based events by hierarchical clustering. With the proliferation of digital cameras, the number of digital photographs accumulating on personal computers is growing rapidly. Individual digital image files, which are typically in the JPEG image file format, includes a wealth of meta-data in the digital files, typically stored in a standard exchangeable image file format (Exif). Such meta-data includes a timestamp that indicates when the photograph was taken or when subsequently re-saved or modified. Nevertheless, because a plurality of meta-data may be recorded with the image file, such information as the original timestamp, or any subsequent modified timestamp, may be separately recorded as meta-data and can be individually extracted and analyzed using various exemplary embodiments of systems and methods according to this invention.

In one exemplary embodiment, a clustering of 512 photographs were used. First, all photographs had timestamps (meta-data), and Were placed manually into meaningful folders, i.e., specific events, by a photographer. This manual clustering of these photographs will be referred to in the following discussion as the ground truth clustering.

The Exif header for each photograph was first processed to extract the timestamp for that photograph. The extracted timestamps were first organized and ordered in time. The timestamps were ordered chronologically using any basic time unit, such as minutes. However, once the timestamps were chronologically ordered, then each timestamp, and thus each corresponding photograph, was given an index or time order number or value, and was subsequently thereafter referred to by this index, rather than by the absolute time value of the timestamp.

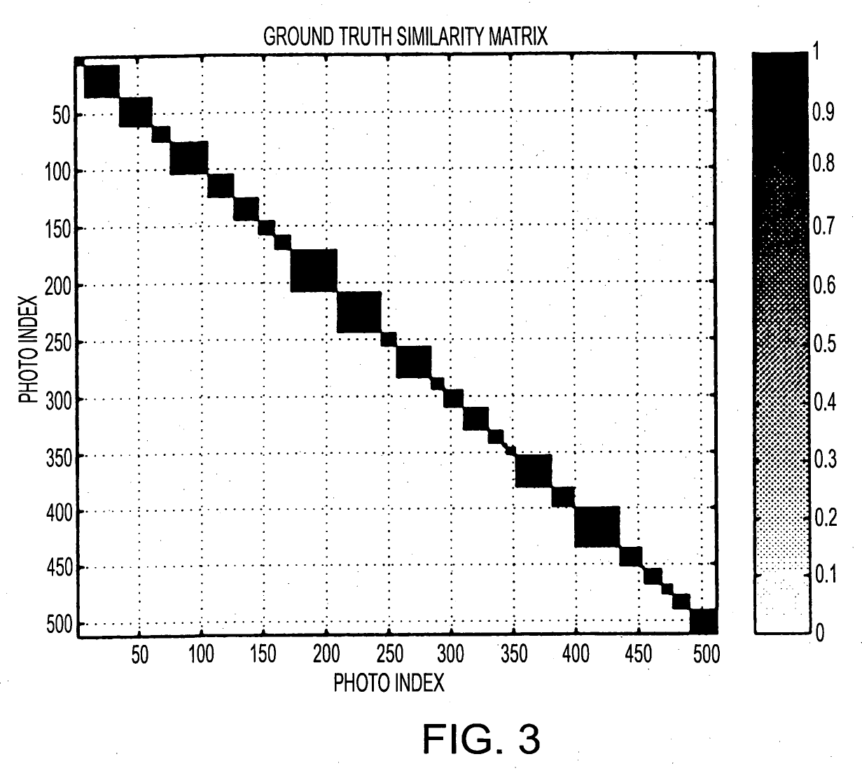

After the initial processing to extract the timestamps and organize the photographs, the structure of the collection of timestamps was assessed by building a similarity matrix Sₖ. FIG. 3 graphically illustrates the results obtained for the similarity matrix Sₖ generated from the ground truth clustering. The values for the elements of the similarity matrix Sₖ that produced the graphic representation in FIG. 3 are 1 for pair of photographs from the same folder and 0 for pairs of photographs that are stored in different folders by the photographer. The photographs are indexed, as indicated above, in time order. To determine the value for the (i,j) element of the similarity matrix Sₖ, the names of the folders in which i^{th} and j^{th} photographs were stored are compared. If they are the same, the (i,j) element is assigned a value of 1. Otherwise, it is assigned a value of 0. In various exemplary embodiments, the blocks of elements of the similarity matrix Sₖ along the main diagonal of the matrix correspond to the groups of photographs in each folder.

A checkerboard pattern along the main diagonal of the similarity matrix Sₖ shown in FIG. 3 indicates the boundary between the folders containing the photographs that are already grouped into distinct events. Therefore, the checkerboard pattern is a graphical representation of the boundaries in time order between groups of photographs of different events. The checkerboard pattern shows that when photographs are represented as the i^{th} and j^{th} elements of the similarity matrix, the photographs are contiguous in the similarity matrix while the events they depict are also disjoint in time.

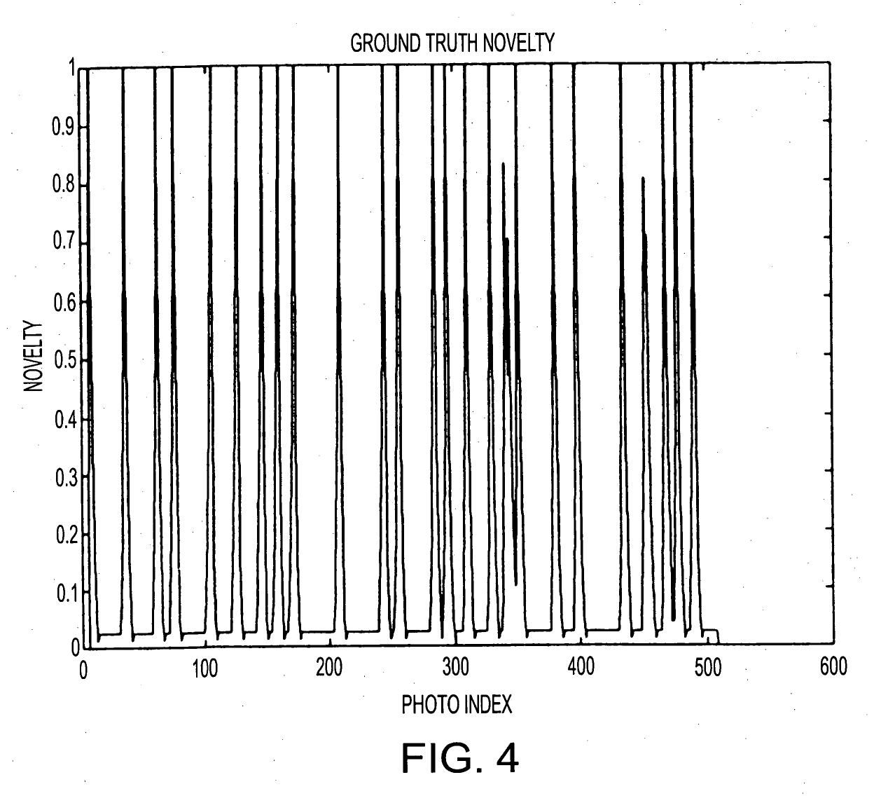

FIG. 4 shows the novelty scores v_{K} generated for the ground truth clustering. The novelty scores v_{K} are obtained using a Gaussian-tapered 11×11 checkerboard kernel g. FIG. 4 shows that the peaks of the novelty scores v_{K} correspond to the checkerboard shown in FIG. 3. For example, in FIG. 3, two relatively large groups represented by two black squares are separated near the index value 210. The two squares are just touching near the index value 210. The point where the two squares just touch represents the boundary between the two groups of photographs. In FIG. 4, there is a corresponding peak in the novelty score v_{K} near the index value 210 that represents this boundary.

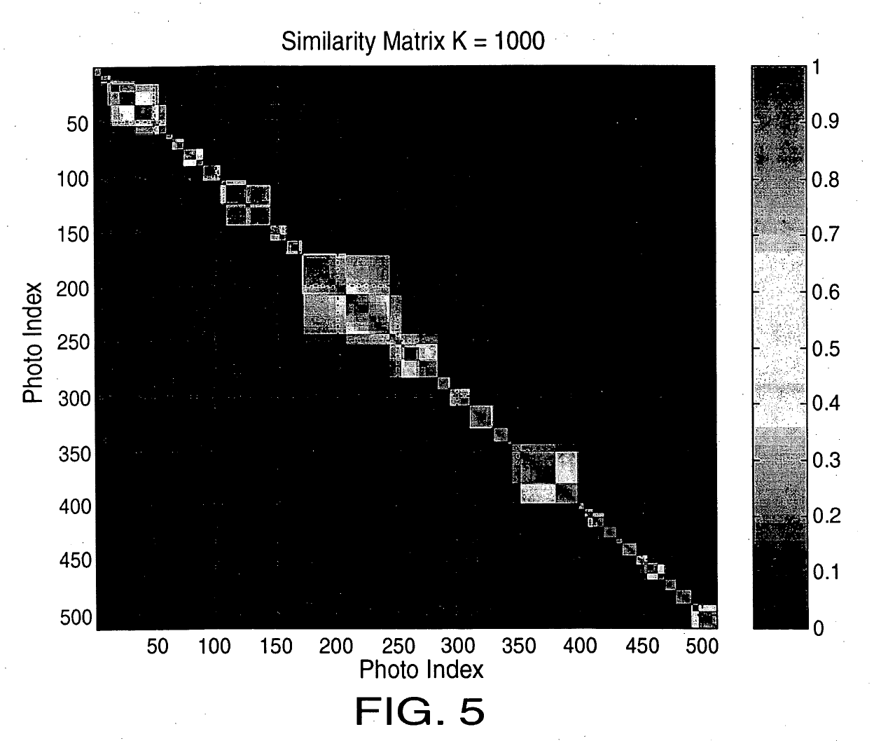

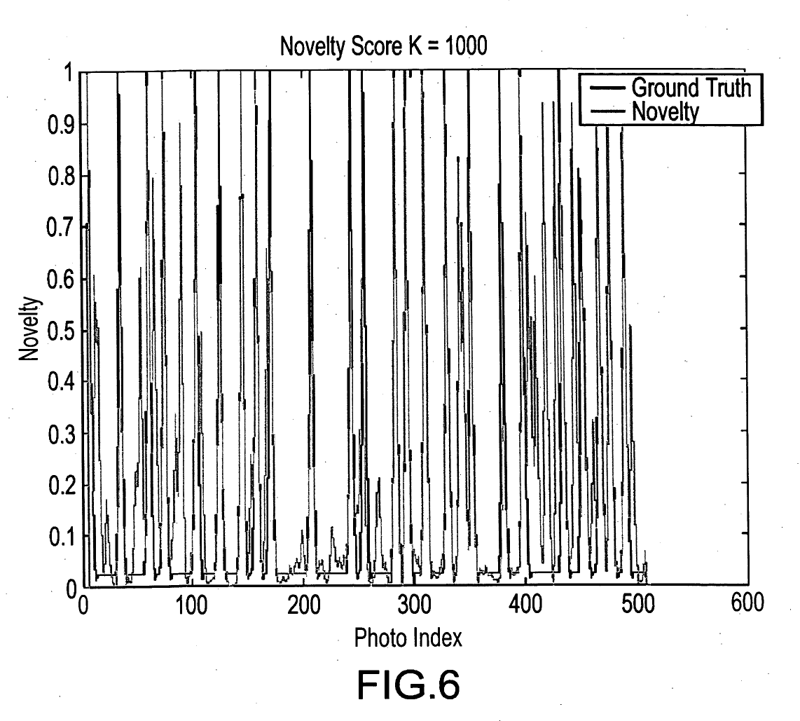

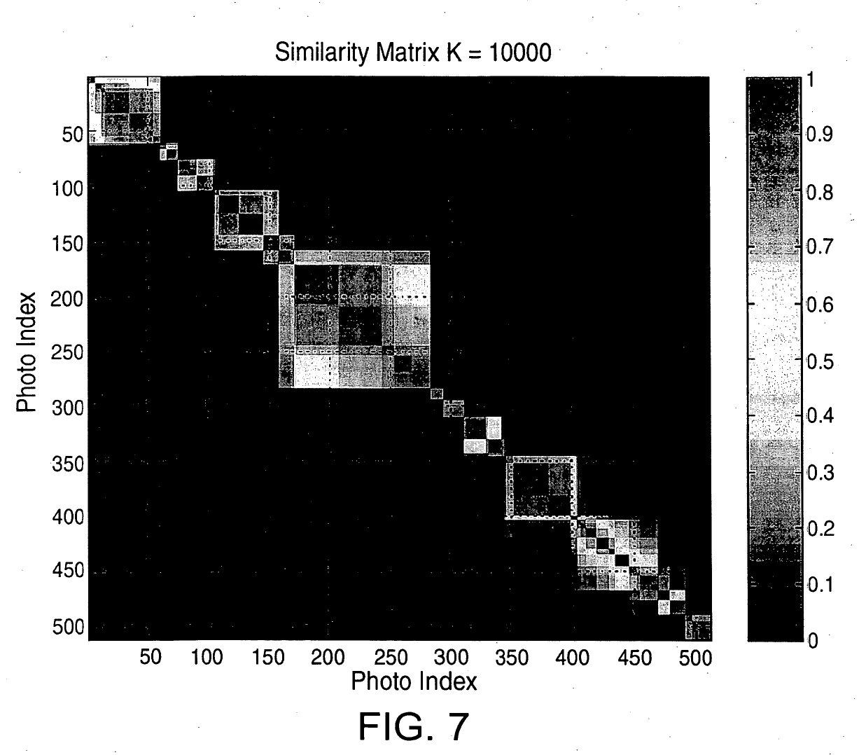

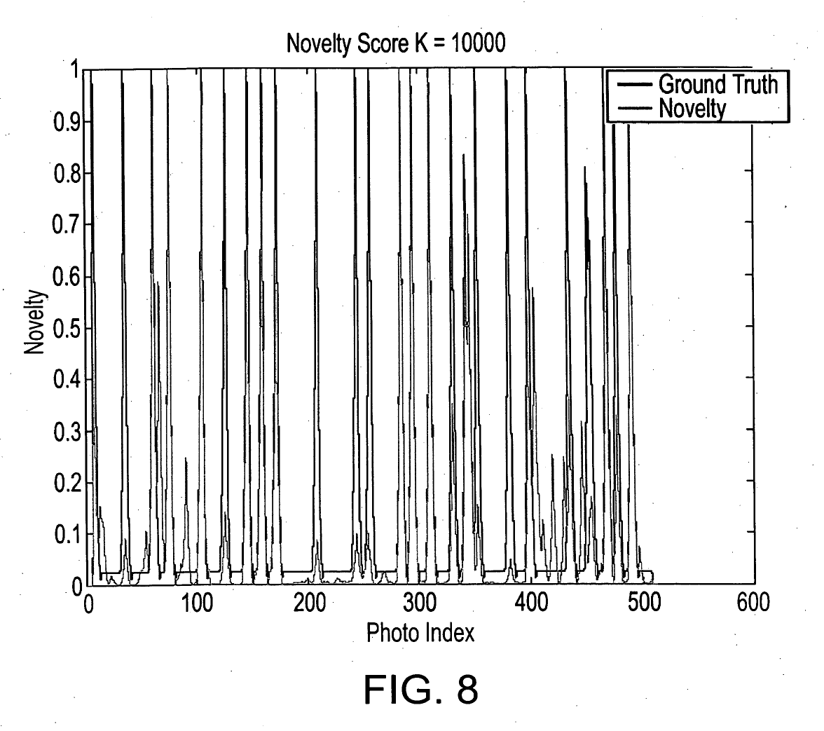

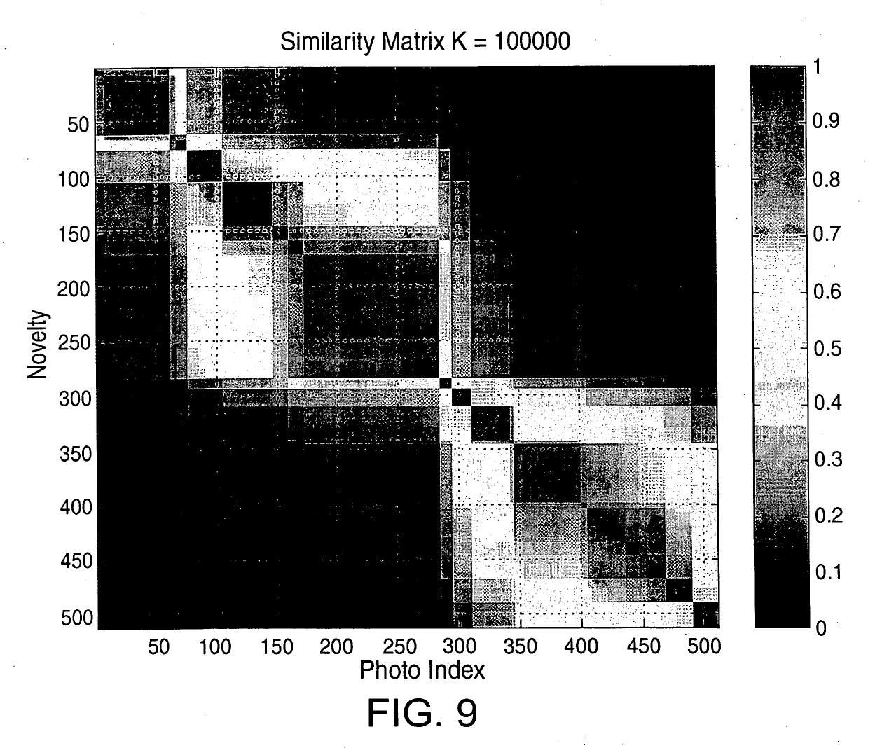

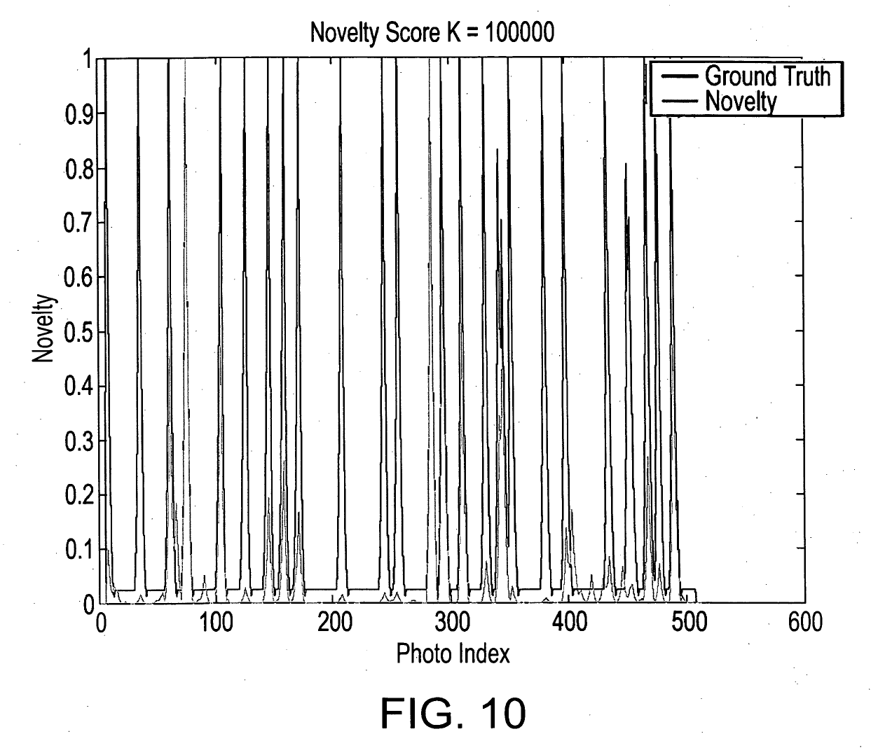

FIGS. 5-10 show several similarity matrixes S_{K} and their corresponding novelty scores v_{K} obtained for values of the parameter K of 1 minutes, 1 minutes, and 10 minutes using the photographs clustered in the ground truth clustering. FIGS. 5, 7 and 9 show the similarity matrixes S_{K} for values of the parameter K of 10³ minutes, 10⁴ minutes, and 10⁵ minutes, respectively. FIGS. 6, 8 and 10 show the novelty scores v_{K} for values of the parameter K of 10³ minutes, 10⁴ minutes, and 1 minutes, respectively. The three different values for the parameter K represent three different resolutions. Specifically, the lesser the value for the parameter K, the greater the resolution, where finer dissimilarities between the groups of timestamps become apparent.

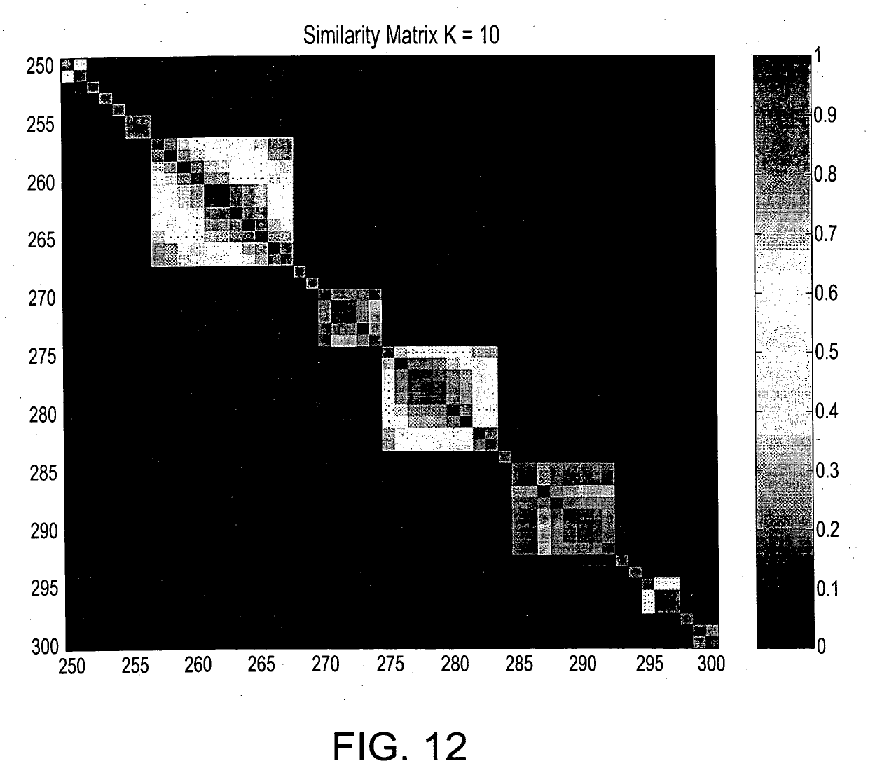

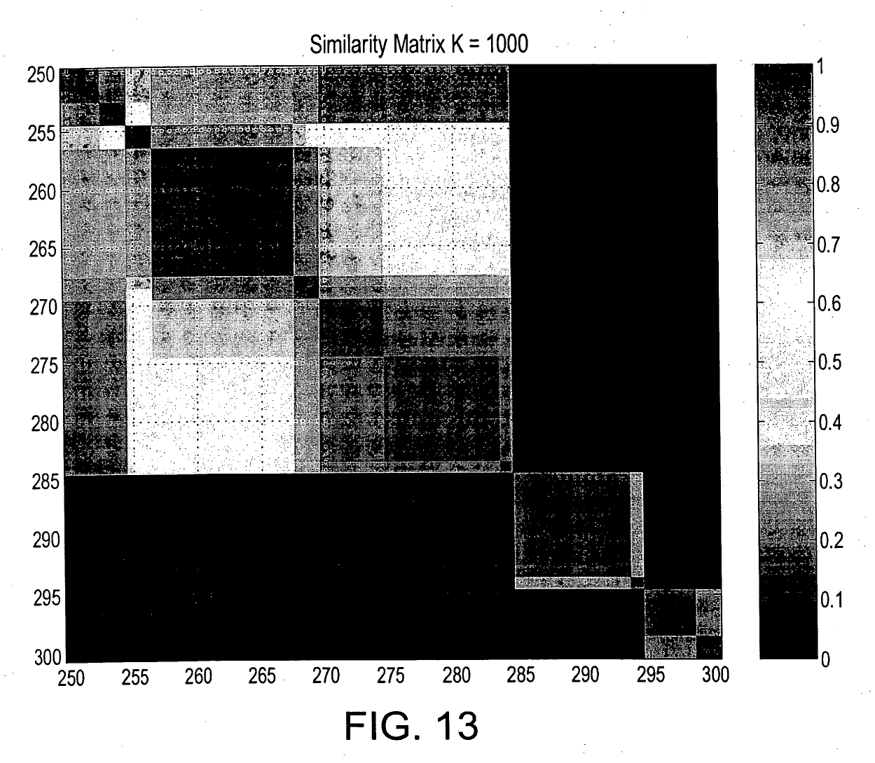

As shown in FIGS. 5, 7, and 9, the similarity matrices S_{K} reveal structures at different resolutions. Nevertheless, at greater values for the parameter K, the details do not appear as readily as for lesser values for the parameter K. Extreme examples of using of a value for the parameter K is shown in FIGS. 12 and 13. Using an exemplary photo index as it appears in two different similarity matrices, FIG. 12 shows a portion of the similarity matrix obtained for a value of 10 for the parameter K (K=10). FIG. 13 shows a portion of the similarity matrix obtained for a value of 1,000 for the parameter K (K=1,000). As shown in FIGS. 12 and 13, better boundary definitions can be obtained with a lesser value for the parameter K than can be obtained with a greater value for the parameter K. This occurs because the photographs in the clusters on either side of a boundary exhibit different within-class similarities for different values of the parameter K, due to Eq. (1). This in turn varies the strength of the correlation with the checkerboard kernel. Therefore, the similarity measure S_{K} can be tailored to integrate or emphasize other features, such as low-level image features, GPS data, or other meta-data.

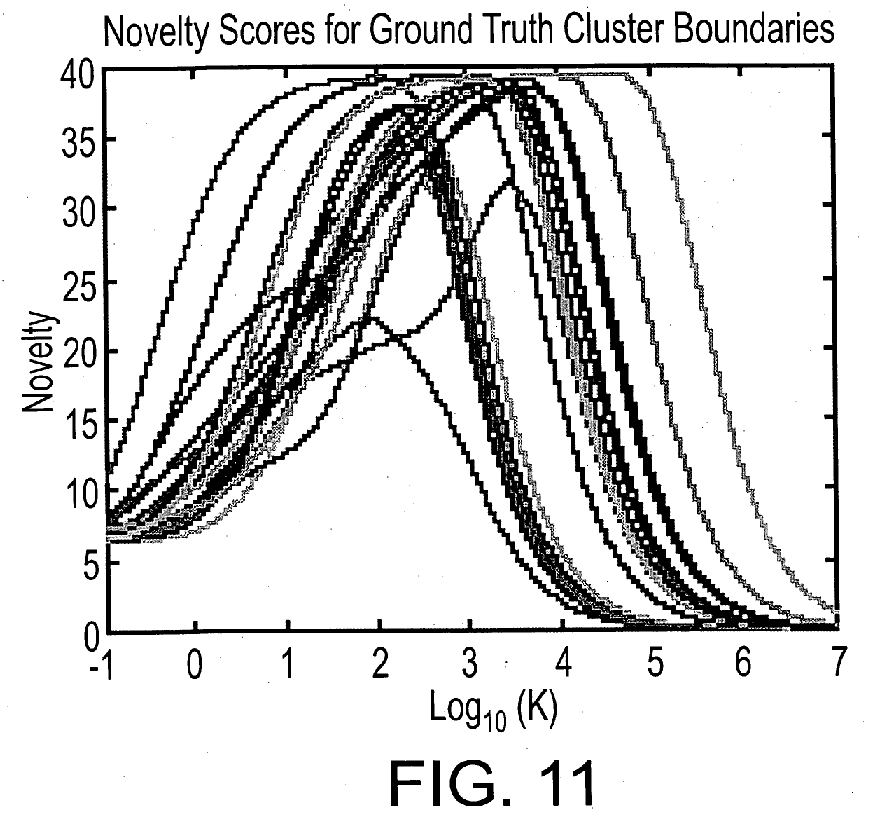

As discussed above, different features become more apparent at different values of the parameter K. In the corresponding novelty scores v_{K}, the boundary points vary considerably depending on the scale of the analysis, i.e., value of the parameter K. In FIGS. 6, 8 and 10, the novelty scores v_{K} for a limited number of values of the parameter K are shown. However, in FIG. 11, novelty scores v_{K} for much greater number of values of the parameter K are shown. As shown in FIG. 11, the novelty scores v_{K} vary widely with the values of the parameter K, and the novelty scores v_{K} show different boundary peaks at different scales or values of the parameter K. This occurs because different events have different time extents. That is, events such as a vacation or a birthday party will have different time extents. For example, the latter event will generally have a shorter time extent than that of the former event.

In FIG. 11, the minimum novelty scores v_{K} correspond to regions of high self-similarity in S_{(K)}, or low novelty. Thus, the boundaries are preferentially located between regions of such high self-similarity. The boundaries are ordered by decreasing value of the parameter K and a hierarchical structure is imposed on the detected boundaries. Such a hierarchy may be enforced on the detected boundaries. In other words, a set of hierarchal boundaries may be created where all the detected boundaries from a very coarse scale (high K value) is included in the set of boundaries for the finer scales. Using this technique enables more prominent boundaries to be retained as less prominent boundaries are further detected.

The technique is based on the assumption that detected event boundaries must, at some scale or, for some value of the parameter K, approach a maximum novelty score. For each value of the parameter K, the peaks in the novelty score v_{K} that indicate a boundary are detected by analysis of the first difference. Using a given threshold score avoids detecting spurious peaks that may appear, for example, because of an unusually long gap in the time values in photographs that are of the same event. Such a given threshold score may be used as a minimum threshold score. For example, a novelty score which is greater than 5 can be selected as a peak in each contiguous region.

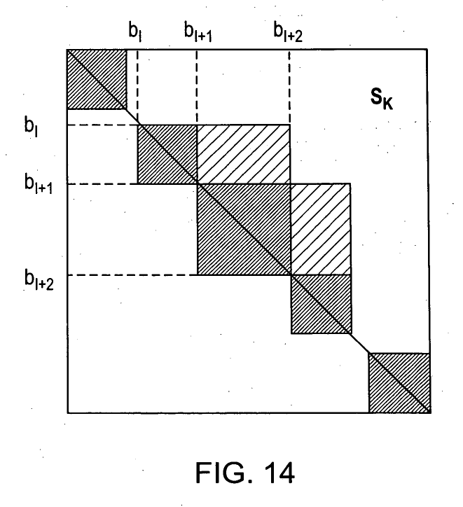

FIG. 14 illustrates the idea of quantifying the confidence in the inferred clusters, which is the difference of the average within-class similarity between the values for the selected meta-data elements within each cluster, and the average between-class similarity between values for the selected meta-data elements in adjacent clusters, as expressed by Equation (4). The within-class similarity terms are the averages over the terms of regions along the main diagonal. The between-class similarity terms are the average of the rectangular regions off the main diagonal. FIG. 14. graphically illustrates the computation of the confidence score.

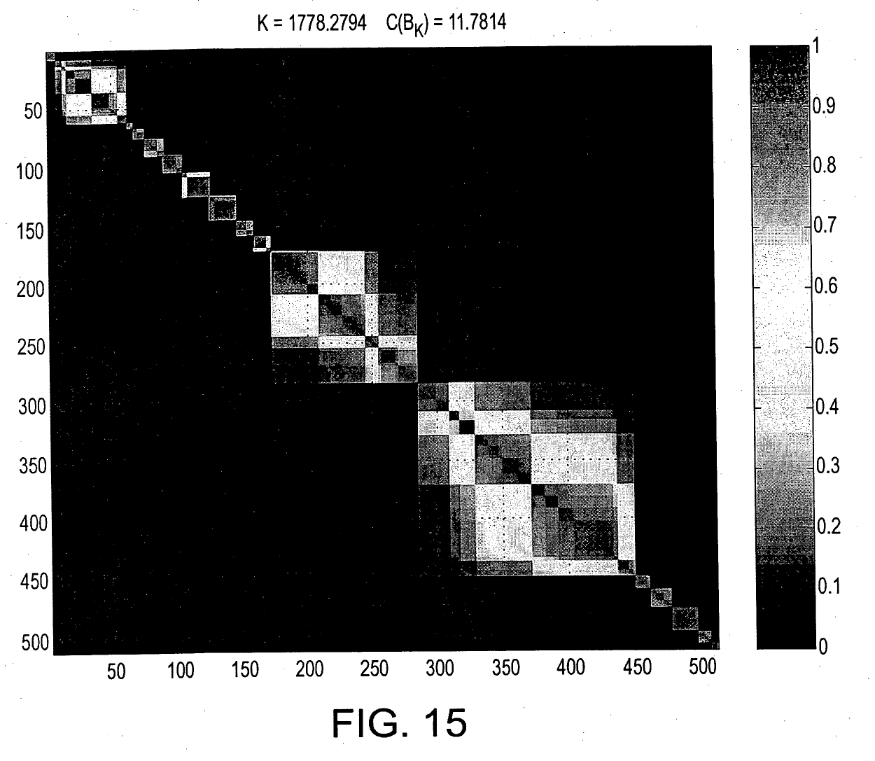

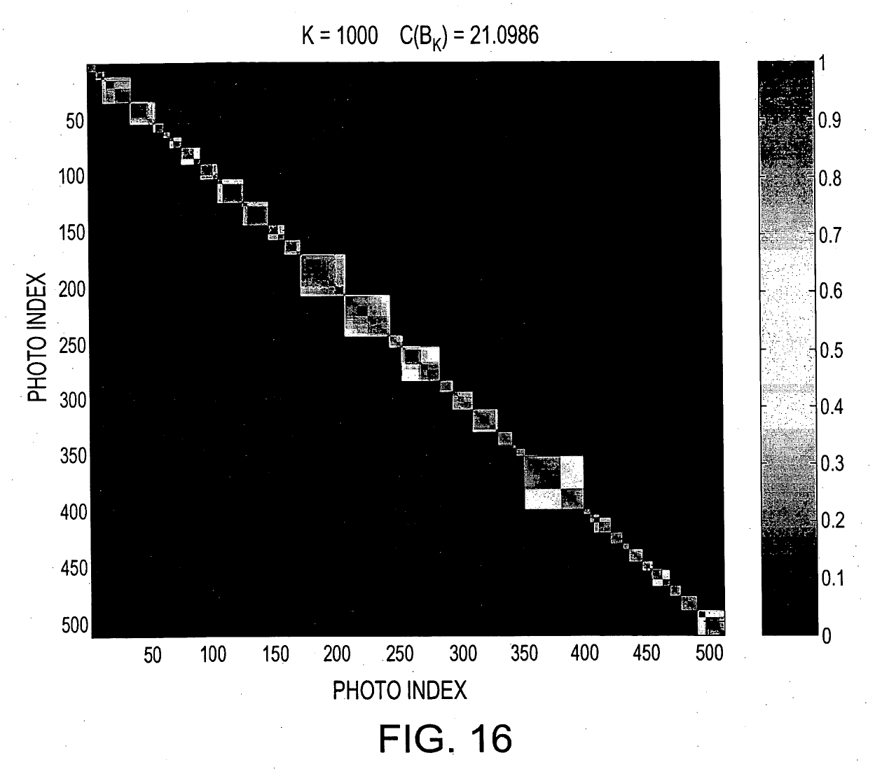

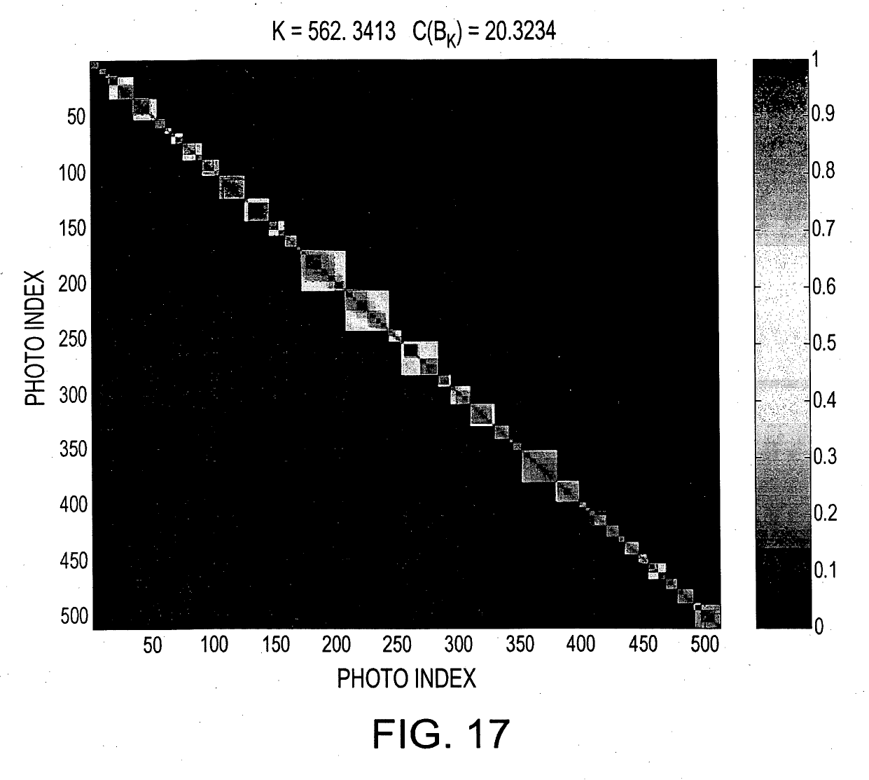

This confidence measure C(B_{K}) depends explicitly on both the number of detected clusters and the values of the parameter K. FIGS. 15-17 illustrate the behavior. FIGS. 15-17 show the regions of the respective similarity matrices SK averaged and summed to form the confidence measure defined in Eq. (4). FIG. 15 shows the matrix for a value of 1778.28 for the parameter K (K=1778.28). FIG. 16 shows the matrix for K=1,000. Finally, FIG. 17 shows the matrix for K=562.34. In the matrix representations shown in FIGS. 15-17, elements not contributing to C(B_{K}) are set to zero in the matrices. In FIGS. 15-17, a lower confidence score for greater values of the parameter K is obtained than for the lower values for the parameter K. For example, for K=1,000 (FIG. 16), the confidence score C(B_{K}) is 21.09886, which is greater than the confidence score C(B_{K}) of 11.7814 for K=1778.28 (FIG. 15). In fact, FIG. 16 shows fewer clusters in number and clustered regions for relatively low similarity. On the other hand, the matrix for K=562.34 of FIG. 17 shows more clusters than the matrix for K=1,000 of FIG. 16, but because the value of the parameter K is smaller, regions of low similarity are clustered. Thus, it should be appreciated that, in various exemplary embodiments, one appropriate scale for similarity analysis is emphasized by the confidence measures.

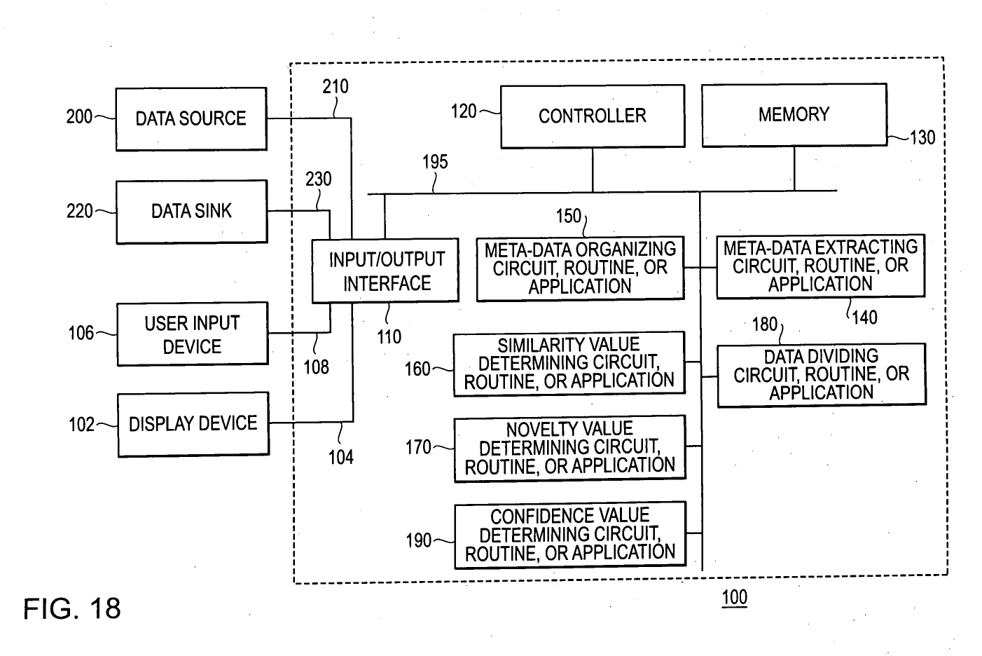

FIG. 18 is a block diagram of one exemplary embodiment of a data organizing system 100 according to this invention. As shown in FIG. 18, the data organizing system 100 includes an input/output interface 110, a controller 120, a memory 130, a meta-data extracting circuit, routine, or application 140, a meta-data organizing circuit, routine, or application 150, a similarity value determining circuit, routine, or application 160, a novelty value determining circuit, routine, or application 170, a data dividing circuit, routine, or application 180, and a confidence value determining circuit, routine, or application 190 interconnected by one or more control and/or data busses and/or application programming interfaces 195.

As shown in FIG. 18, a display device 102, one or more user input device(s) 106, a data source 200, and a data sink 220 are connected to the data organizing system 100 by links 104, 108, 210 and 230, respectively.

In general, the data source 200 shown in FIG. 18 can be any known or later-developed device that is capable of providing data files and their corresponding meta-data to the data organizing system 100. In general, the data sink 220 shown in FIG. 18 can be any known or later-developed device that is capable of receiving any data from the data organizing system 100.

The data source 200 and/or the data sink 220 can be integrated with the data organizing system 100. Additionally, the data organizing system 100 may be integrated with devices providing additional functions in addition to the data source 200 and/or the data sink 220, in a larger system that performs multiple functions, such as a digital camera that automatically organizes the captured photographs into folders.

Each of the respective one or more user input device(s) 106 may be one or any combination of multiple input devices, such as a keyboard, a mouse, a joy stick, a trackball, a touch pad, a touch screen, a pen-based system, a microphone and associated voice recognition software, or any other known or later-developed device for inputting data and/or user commands to the data organizing system 100. It should be understood that the one or more user input device(s) 106, of FIG. 18 do not need to be the same type of device.

Each of the links 104, 108, 210 and 230 connecting the a display device 102, one or more user input device(s) 106, a data source 200, a data sink 220 to the data organizing system 100 can be a signal line, a direct cable connection, a modem, a local area network, a wide area network, and intranet, the Internet, any other distributed processing network, or any other known or later developed connection device or structure. It should be appreciated that any of these links 104, 108, 210 and 230 may include wired or wireless portions. In general, each of the links 104, 108, 210 and 230 can be implemented using any known or later-developed connection system or structure usable to connect the respective devices to the data organizing system 100. It should be understood that the links 104, 108, 210 and 230 do not need to be of the same type.

As shown in FIG. 18, the memory 130 can be implemented using any appropriate combination of alterable, volatile, or non-volatile memory or non-alterable, or fixed, memory. The alterable memory, whether volatile or non-volatile, can be implemented using any one or more of static or dynamic RAM, a floppy disk and disk drive, a writeable or rewriteable optical disk and disk drive, a hard drive, flash memory or the like. Similarly, the non-alterable or fixed memory can be implemented using any one or more of ROM, PROM, EPROM, EEPROM, and an optical ROM disk, such as a CD-ROM or DVD-ROM disk and disk drive or the like.

Various embodiments of the data organizing system 100 can be implemented as software executing on a programmed general purpose computer, a special purpose computer, a microprocessor or the like. It should also be understood that each of the circuits, routines, and/or applications shown in FIG. 18 can be implemented as portions of a suitably programmed general-purpose data processor. Alternatively, each of the circuits, routines, and/or applications shown in FIG. 18 can be implemented as physically distinct hardware circuits within an ASIC, a digital signal processor (DSP), a FPGA, a PLD, a PLA and/or a PAL, or discrete logic elements or discrete circuit elements. In general, any device capable of implementing a finite state machine, that is in turn capable of implementing the flowcharts shown in FIGS. 1 and 2, can be used to implement the data organizing system 100. The particular form of the circuits, routines, applications, objects and/or managers shown in FIG. 18 will take is a design choice and will be obvious and predictable to those skilled in the art. It should be appreciated that the circuits, routines, applications, objects and/or managers shown in FIG. 18 do not need to be of the same design.

The meta-data extracting circuit, routine, or application 140 extracts at least one meta-data element associated with a data file. At least one element of the meta-data of each data file is extracted from the plurality of data files to be organized. Data files such as digital image files, which are typically in the JPEG image file format, includes a wealth of meta-data in the digital files, typically stored in a standard exchangeable image file format (Exif). Such extractable meta-data includes a timestamp that indicates when the photograph was taken or when subsequently re-saved or modified.

The meta-data organizing circuit, routine, or application 150 organizes the extracted meta-data element into a desired order based on values for the extracted meta-data elements. The extracted meta-data elements are organized using any desired organizing characteristic, such as the chronological, alphabetical, numerical and/or positional characteristic, and can order the extracted meta-data element based on an assigned identification value, or indexed.

The similarity value determining circuit, routine, or application 160, determines for at least one of the at least one parameter value, a similarity value for at least two of the plurality of data files using at least some of the extracted meta-data elements and that parameter value. Therefore, the similarity value determining circuit, routine, or application 160 compares the meta-data for at least a pair of data files using the parameter value to obtain the similarity value of each such pair of the data files.

The novelty value determining circuit, routine, or application 170, determines at least one novelty value for that data file based on the plurality of similarity values. That is, the novelty value determining circuit, routine, or application 170 determines the novelty value based on the similarity values for a desired number of data files.

The data dividing circuit, routine, or application 180 divides at least some of the data files into groups based on the extracted meta-data elements and an input parameter value. In various exemplary embodiments, the data dividing circuit, routine, or application 180 divides the at least some of the data files into groups based on the extracted meta-data elements and an input parameter value by determining at least one boundary location between ones of the plurality of data files based on the at least one novelty value determined for at least some of the data files, and determining, for at least some of the determined boundary locations, the at least one parameter value that maximizes the confidence value.

The confidence value determining circuit, routine, or application 190 determines, for at least some of the determined boundary locations, a confidence value for that boundary location.

In operation, the data organizing system 100 inputs or otherwise obtains a plurality of data files, each with its corresponding meta-data, and may input the value for the input parameter from the data source 200 over the link 210 and/or reads one or more data files from the memory 130. The input parameter may be input through the user input device 106. If obtained from the data source 200, the input/output interface 110 inputs the data files and/or the input parameter, and, under the control of the controller 120, forwards any appropriate data files to the meta-data extracting circuit, routine, or application 140.

The meta-data extracting circuit, routine, or application 140 extracts at least one meta-data element associated with at least some of the input data files. The meta-data extracting circuit, routine, or application 140 then, under the control of the controller 120, stores the extracted meta-data elements to the memory 130, or outputs the extracted meta-data elements directly to the meta-data organizing circuit, routine, or application 150. The meta-data organizing circuit, routine, or application 150 inputs, under control of the controller 120, the extracted meta-data elements and organizes the extracted meta-data elements into a desired order based on values for the extracted meta-data elements. The meta-data organizing circuit, routine, or application 150 then, under the control of the controller 120, stores the ordered extracted meta-data to the memory 130 or outputs the ordered extracted meta-data elements directly to the similarity value determining circuit, routine, or application 160.

The similarity value determining circuit, routine, or application 160 inputs, under control of the controller 120, the ordered meta-data elements and/or the corresponding data files and determines, for at least one of the at least one parameter value, a similarity value for at least one pair of two of the plurality of data files using at least some of the extracted meta-data elements and/or the contents of those data files and that parameter value. The similarity value determining circuit, routine, or application 160 then, under the control of the controller 120, stores the determined similarity values to the memory 130 or outputs the determined similarity values directly to the novelty value determining circuit, routine, or application 170.

The novelty value determining circuit, routine, or application 170 inputs, under control of the controller 120, at least some of the similarity values and determines, for each of a number of data files associated with the input similarity values, at least one novelty value for each such data file based on similarity values for that data file and a desired number of surrounding data files. The novelty value determining circuit, routine, or application 170, then, under the control of the controller 120, stores the determined novelty values to the memory 130 or outputs the determined novelty values directly to the data dividing circuit, routine, or application 180.

The data dividing circuit, routine, or application 180 inputs, under control of the controller 120, at least some of the novelty values and divides the corresponding data files into groups by determining at least one boundary location between various ones of the plurality of data files based on the at least one novelty value determined for at least some of the data files. The data dividing circuit, routine, or application 180, then, under the control of the controller 120, stores the determined boundary location to the memory 130 or outputs the determined boundary location to the confidence value determining circuit, routine, or application 190.

The confidence value determining circuit, routine, or application 190 inputs, under control of the controller 120, one or more boundary locations, and determines, for at least some of the determined boundary locations, a confidence value for that boundary location for at least some of the determined boundary locations. The confidence value determining circuit, routine, or application 190, then, under the control of the controller 120, stores the determined confidence value to the memory, or outputs the determined confidence value to the data dividing circuit, routine, or application 180. The data dividing circuit, routine, or application 180 then determines the at least one parameter value that maximizes the confidence value for at least some of the determined boundary locations. Therefore, in operation of the data organizing system 100, the input parameter value, the extracted ordered meta-data elements, and/or the contents of the corresponding data files are organized using the at least some of the read/received data files into groups based on the ordered extracted meta-data elements and/or the corresponding contents of the data files and the input parameter value. The divided, and thus organized, data files can then be further stored in the memory 130, output to the data sink 220 and/or displayed on the display device 102.

While FIG. 18 shows the data organizing unit 100 as a separate device from the display device 102, the user input device 106, the data source 200 and/or the data sink 220, and the data organizing system 100 may be an integrated device. In an integrated configuration, two or more of the data organizing system 100, from the display device 102, the user input device 106, the data source 200 and/or the data sink 220 may be contained in a single device.

Alternatively, the data organizing system 100 may be a separate device including the meta-data extracting circuit, routine or application 140, the meta-data organizing circuit, routine or application 150, the similarity value determining circuit, routine or application 160, the novelty value determining circuit, routine or application 170, the data dividing circuit, routine or application 180, and the confidence value determining circuit, routine or application 190, the controller 120, the memory 130, and/or the input/output interface 110. Furthermore, although shown as separate circuits, routines, and/or applications, the meta-data extracting circuit, routine, or application 140, the meta-data organizing circuit, routine, or application 150, the similarity value determining circuit, routine, or application 160, the novelty value determining circuit, routine, or application 170, the data dividing circuit, routine, or application 180, and the confidence value determining circuit, routine, or application 190 may themselves be integrated together with various combination.

While this invention has been described in conjunction with the exemplary embodiments outlined above, various alternatives, modifications, variations, improvements, and/or substantial equivalents, whether known or that are or may be presently unforeseen, may become apparent to those having at least ordinary skill in the art. Accordingly, the exemplary embodiments of the invention, as set forth above, are intended to be illustrative, not limiting. Various changes may be made without departing from the spirit and scope of the invention. Therefore, the claims as filed and as they may be amended are intended to embrace all known or later-developed alternatives, modifications, variations, improvements, and/or substantial equivalents.

1. A method for organizing a plurality of data files using meta data, having at least one meta data element, at least associated with each data file, the method comprising:
extracting, for at least some of the data files, at least one meta-data element associated with that data file;
organizing the extracted meta-data elements in a desired order based on values for the extracted meta-data elements;
inputting at least one parameter value; and
dividing at least some of the data files into groups based on the extracted meta-data elements and the input parameter value.

2. The method of claim 1, wherein dividing the at least some data files comprises determining, for each of at least one of the at least one parameter value, a similarity value for at least two of the plurality of data files using at least some of the extracted meta-data elements and that parameter value.

3. The method of claim 2, wherein determining the at least one similarity value comprises determining the at least one similarity value as:
$${S}_{K} ( i , j ) = exp ( - \frac{\vert {t}_{i} - {t}_{j} \vert}{K} ) ,$$
where:
S_{K} (i,j) is the similarity value for the i^{th} data file and the j^{th} data file;
K is the parameter value; and
tᵢ and tⱼ are actual values of at least one meta-data element of the at least one extracted meta-data elements for the i^{th} and j^{th} data files.

4. The method of claim 2, wherein determining the at least one similarity value comprises determining the at least one similarity value as:
$${S}_{K} ( i , j ) = exp ( \frac{1}{K} ( \frac{\text{<} {v}_{i} , {v}_{j} \text{>}}{\vert {v}_{i} \vert \vert {v}_{j} \vert} - 1 ) ) .$$
where:
S_{K} (i,j) is the similarity value for the i^{th} data file and the j^{th} data file;
K is the parameter value; and
vᵢ and vⱼ are actual vector values determined from the i^{th} and the j^{th} data files.

5. The method of claim 2, further comprising determining, for each of at least some data files, at least one novelty value for that data file based on the at least one similarity value for that data file and for a number of nearby data files.

6. The method of claim 5, wherein determining at least one novelty value comprises determining at least one novelty value as:
$${v}_{K} ( s ) = {\sum }_{l , n = - 5}^{5} {S}_{K} ( s + 1 , s + n ) g ( 1 , n ) .$$
where:
v_{K}(S) is the novelty value; and
g is a Gaussian tapered 11×11 checkerboard kernel.

7. The method of claim 5, further comprising determining at least one boundary location between ones of the plurality of data files based on the at least one novelty value determined for at least some of the data files.

8. The method of claim 7, further comprising determining, for at least some of the determined boundary locations, a confidence value for that boundary location.

9. The method of claim 8, wherein determining a confidence value for a boundary location comprises determining the confidence value as:
$$C ( {B}_{K} ) = {\sum }_{l = 1}^{\vert {B}_{K} \vert - 1} \frac{1}{{( {b}_{l + 1} - {b}_{1} )}^{2}} {\sum }_{i , j = {b}_{1}}^{{b}_{l + 1}} {S}_{K} ( i , j ) - {\sum }_{l = 1}^{\vert {B}_{K} \vert - 2} \frac{1}{( {b}_{l + 1} - {b}_{1} ) ( {b}_{l + 2} - {b}_{l + 1} )} {\sum }_{i = {b}_{1}}^{{b}_{l + 1}} {\sum }_{j = {b}_{l + 1}}^{{b}_{l + 2}} {S}_{K} ( i , j ) .$$
where:
C(B_{K}) is the confidence value for the B_{K}^{th} boundary;
S_{K} (i,j) is the similarity value for the i^{th} data file and the j^{th} data file;
b is the index value of detected boundary at a particular value for the input parameter K level.

10. The method of claim 8, further comprising determining, for at least some of the determined boundary locations, at least one of the at least one parameter value that maximizes the confidence value.

11. A method for organizing a plurality of data files using meta-data having at least one meta-data element that is at least associated with a corresponding one of the data files, the method comprising:
processing at least one set of meta-data, where each meta-data corresponds to a data file;
obtaining a desired value for analyzing the meta-data; and
determining a structure within the set of meta-data elements using an obtained parameter value, wherein the structure is determined by comparing, for at least a subset of the plurality of data files, at least a subset of the meta-data using the parameter value to each other.

12. The method of claim 11, further comprising clustering the data files into groups using the determined structure of the meta-data.

13. The method of claim 12, further comprising determining boundaries from the determined clusters of data files, wherein the boundaries are located between the determined clusters of data files.

14. The method of claim 13, further comprising:
determining a similarity value by comparing at least some of the meta-data elements in one cluster of data files to at least some other ones of the meta data elements in that element cluster of data files; and
determining a dissimilarity value by comparing at least some of the meta-data elements in one cluster of data files to at least some of the meta-data elements in another cluster of data files.

15. The method of claim 14, further comprising:
determining a value corresponding to a desired grouping of the clusters of data files based on the differences of the similarity values and the dissimilarity values.

16. A storage medium storing a set of program instructions executable on a data processing device and usable to organize a plurality of data files by using meta data having at least one meta data element at least associated with each data file, the program comprising:
instructions for extracting for at least some of the data files, at least one meta-data element associated with that data file;
instructions for organizing the extracted meta-data elements in a desired order based on values for the extracted meta-data elements;
instructions for inputting a parameter value; and
instructions for dividing at least some of the data files into groups based on the extracted meta-data elements and the input parameter value.

17. The storage medium of claim 16, instructions for dividing at least some of the data files into groups further comprising instructions for determining, for each of at least one of the at least one parameter value, a similarity value for at least two of the plurality of data files using at least some of the extracted meta-data elements and that parameter value.

18. The storage medium of claim 17, further comprising instructions for determining, for each of at least some data files, at least one novelty value for that data file based on the at least one similarity value for that data file and for a number of nearby data files.

19. The storage medium of claim 17, wherein instructions for determining the at least one similarity value comprises instructions for determining the at least one similarity value as:
$${S}_{K} ( i , j ) = exp ( - \frac{\vert {t}_{i} - {t}_{j} \vert}{K} ) ,$$
where:
S_{K} (i,j) is the similarity value for the i^{th} data file and the j^{th} data file;
K is the parameter value; and
tᵢ and tⱼ are actual values of at least one meta-data element of the at least one extracted meta-data element for the i^{th} and j^{th} data files.

20. The storage medium of claim 17, wherein instructions for determining the at least one similarity value comprises instructions for determining the at least one similarity value as:
$${S}_{K} ( i , j ) = exp ( \frac{1}{K} ( \frac{\text{<} {v}_{i} , {v}_{j} \text{>}}{\vert {v}_{i} \vert \vert {v}_{j} \vert} - 1 ) ) .$$
where:
S_{K} (i,j) is the similarity value for the i^{th} data file and the j^{th} data file;
K is the parameter value; and
vᵢ and vⱼ that are actual vector values determined from the ith and the jth data files.

21. The storage medium of claim 18, further comprising instructions for determining at least one boundary location between ones of the plurality of data files based on the at least one novelty value determined for at least some of the data files.

22. The storage medium of claim 18, wherein instructions for determining at least one novelty value comprises instructions for determining the at least one novelty value as:
$${v}_{K} ( s ) = {\sum }_{l , n = - 5}^{5} {S}_{K} ( s + 1 , s + n ) g ( l , n ) .$$
where:
v_{K}(s) is the novelty value; and
g is the Gaussian tapered 11×11 checkerboard kernel.

23. The storage medium of claim 21, further comprising instructions for determining, for at least some of the determined boundary locations, a confidence value for that boundary location.

24. The storage medium of claim 23, wherein instructions for determining at least one confidence value comprises instructions for determining each of such confidence value as:
$$\begin{matrix}C ( {B}_{K} ) = {\sum }_{l = 1}^{\vert {B}_{K} \vert - 1} \frac{1}{{( {b}_{l + 1} - {b}_{l} )}^{2}} {\sum }_{i , j = {b}_{l}}^{{b}_{l + 1}} {S}_{K} ( i , j ) - \\ {\sum }_{l = 1}^{\vert {B}_{K} \vert - 2} \frac{1}{( {b}_{l + 1} - {b}_{l} ) ( {b}_{l + 2} - {b}_{l + 1} )} {\sum }_{i = {b}_{l}}^{{b}_{l + 1}} {\sum }_{j = {b}_{l + 1}}^{{b}_{l + 2}} {S}_{K} ( i , j ) .\end{matrix}$$
where:
C(B_{K}) is the confidence value for the B_{K}^{th} boundary;
S_{K} (i,j) is the similarity value for the i^{th} data file and the j^{th} data file;
b is the detected boundary at a level.

25. The storage medium of claim 23, further comprising instructions for determining, for at least some of the determined boundary locations, at least one of the at least one parameter value that maximizes the confidence value.

26. A data file organizing system usable to organize a plurality of data files using meta data having at least one meta data element that is at least associated with a corresponding one of the data files, comprising:
a meta-data extracting circuit, routine, or application that extracts, for at least some of the data files, at least one meta-data element associated with that data file;
a meta-data organizing circuit, routine or application that organizes the extracted meta-data elements in a desired order based on values for the extracted meta-data elements;
a similarity value determining circuit, routine or application that determines, for at least one of the at least one parameter value, a similarity value for at least two of the plurality of data files using at least some of the extracted meta-data elements and that parameter value
a novelty value determining circuit, routine or application that determines at least one novelty value for that data file based on the at least one similarity value for that data file and for a number of nearby data files;
a data dividing determining circuit, routine or application that divides at least some of the data files into groups based on the extracted meta-data elements and the input parameter value by determining at least one boundary location between ones of the plurality of data files based on the at least one novelty value determined for at least some of the data files; and
a confidence value determining circuit, routine or application that determines, for at least some of the determined boundary locations, a confidence value for that boundary location, wherein the data dividing circuit, routine, or application further determines, for at least some of the determined boundary locations, the at least one parameter value that maximizes the confidence value.
